(19) United States
(12) Patent Application Publication
(10) Pub. No.: US 2024/0267999 A1
(43) Pub. Date: Aug. 8, 2024

(54) Integrated Warmer Control System

(71) Applicants: Hyundai Motor Company, Seoul (KR); Kia Corporation, Seoul (KR)

(72) Inventors: So La Chung, Seoul (KR); Tae Youb Yi, Yongin-si (KR); Uk Il Yang, Yongin-si (KR); Man Ju Oh, Yongin-si (KR); Hyeon Kyu Yang, Hwaseong-si (KR); Ki Beom Kwon, Seoul (KR)

(21) Appl. No.: 18/347,016

(22) Filed: Jul. 5, 2023

(30) Foreign Application Priority Data
Feb. 3, 2023 (KR) 10-2023-0015053

(51) Int. Cl. H05B 1/02; B60N 2/00; B60N 2/06; B60N 2/14; B60N 2/56

(52) U.S. Cl. CPC H05B 1/0238; B60N 2/002; B60N 2/06; B60N 2/14; B60N 2/5678

(57) ABSTRACT

An embodiment integrated warmer control system includes warmers disposed in and around a seat, a main controller configured to derive a command signal according to a temperature of an operation stage or a plurality of operation stage-specific operation temperatures of each of the warmers based on situation-specific information, and sub-controllers configured to receive the command signal according to the temperature of the operation stage or the plurality of operation stage-specific operation temperatures derived through communication with the main controller and to control the warmers to operate in response to the command signal.

### CROSS-REFERENCE TO RELATED APPLICATIONS

This application claims the benefit of Korean Patent Application No. 10-2023-0015053, filed on Feb. 3, 2023, which application is hereby incorporated herein by reference.

### TECHNICAL FIELD

The present disclosure relates to an integrated warmer control system.

### BACKGROUND

In general, vehicles are provided with a heating ventilation air conditioning (HVAC) system to make the interior space thereof pleasant.

For example, a vehicle HVAC device includes a heater configured to generate warm air, an evaporator configured to generate cold air, a blower configured to supply cold air and warm air, a distribution duct configured to distribute cold air and warm air supplied by the blower, an air duct connected to the distribution duct and extending to both sides of the interior of a vehicle, a side vent and a side duct provided on the air duct, a center duct connected to the distribution duct, a rear heating duct connected to the distribution duct and extending to the bottom of a rear seat, and a rear duct provided on the rear heating duct.

In addition, a warmer device providing heat to passengers seated in seats is used together with the HVAC device in order to obtain an instant heating effect. For such a warmer device, a method of providing warming heat using hot wires disposed inside a seat cushion or a seatback or providing warming heat by generating radiant heat using a heating panel disposed in the bottom of the dashboard or the bottom of a seatback is used.

Recently, warmer devices are provided at a variety of positions for the comfort of indoor occupants in cold weather. It is inconvenient to individually control the temperatures of respective warmer devices. Warming heat may not be efficiently provided to occupants depending on the position of the occupants.

The foregoing is intended merely to aid in the understanding of the background of embodiments of the present disclosure and is not intended to mean that embodiments of the present disclosure fall within the purview of the related art that is already known to those skilled in the art.

### SUMMARY

The present disclosure relates to an integrated warmer control system. Particular embodiments relate to an integrated warmer control system in which a plurality of warmers provided inside a mobility vehicle may be operated at different temperatures so that warming heat may be efficiently provided by respective warmers, thereby improving occupant comfort.

Accordingly, embodiments of the present disclosure keep in mind problems occurring in the related art, and embodiments of the present disclosure propose an integrated warmer control system by which a plurality of warmers provided inside a mobility vehicle operate at different temperatures to efficiently provide warming heat through the warmers, thereby improving occupant comfort.

The embodiments of the present disclosure are not limited to the aforementioned description, and other embodiments not explicitly disclosed herein will be clearly understood by those skilled in in the art from the description provided hereinafter.

According to one embodiment of the present disclosure, there is provided an integrated warmer control system including a plurality of warmers disposed in and around a seat, a main controller deriving a command signal according to one of the temperature of an operation stage or a plurality of operation stage-specific operation temperatures of each of the warmers, on the basis of situation-specific information, and a plurality of sub-controllers provided on the plurality of warmers to control the plurality of warmers, respectively, wherein the plurality of sub-controllers receive the command signal according to one of the temperature of the operation stage or the plurality of operation stage-specific operation temperatures derived through communication with the main controller and control the warmers to operate in response to the input command signal.

The plurality of sub-controllers may be provided on the plurality of warmers, respectively.

Some of the plurality of warmers may be grouped and the sub-controllers are provided according to the groups.

When a user inputs a command through an integrated switch, the main controller may derive one of the temperature of the operation stage or the plurality of operation stage-specific operation temperatures of each of the warmers and transmit the command signal according to derived one of the temperature of the operation stage or the plurality of operation stage-specific operation temperatures to a corresponding one of the sub-controllers.

Connection lines through which temperature information, contact information, and power are transmitted may be electrically connected to each of the sub-controllers. The sub-controllers may receive power from an external source and wirelessly communicate with the main controller.

The main controller may receive information regarding the position of the seat and the posture of an occupant and derive one of the temperature of the operation stage or the plurality of operation stage-specific operation temperatures of each of the warmers on the basis of the information regarding the position of the seat and the posture of the occupant.

The warmers may include a first warmer providing heat to a lower body of the occupant from a front of the seat and a second warmer providing heat to the lower body of the occupant from a side of the seat.

When the seat is converted into a sleep mode, the main controller may adjust one of the temperature of the operation stage or the plurality of operation stage-specific operation temperatures of each of the first warmer and the second warmer to a lower temperature according to the position of the seat in the sleep mode.

When the seat is converted to a facing mode to face a rear seat, the main controller may control the first warmer to be off and the second warmer to maintain one of the temperature of the operation stage or the plurality of operation stage-specific operation temperatures.

When the seat moves toward the first warmer provided in front thereof, the main controller may adjust one of the temperature of the operation stage or the plurality of operation stage-specific operation temperatures of the first warmer to a lower temperature according to a distance of forward movement of the seat. When the seat moves away from the first warmer, the main controller may adjust one of the temperature of the operation stage or the plurality of operation stage-specific operation temperatures of the first warmer to a higher temperature according to a distance of backward movement of the seat.

The warmers may include a third warmer provided on a seatback of the seat to provide heat to a lower body of a rear seat occupant. When the seat is moved backwards or the angle of the seatback is adjusted backward, the main controller may adjust one of the temperature of the operation stage or the plurality of operation stage-specific operation temperatures of the third warmer to a lower temperature according to a distance of movement of the seat and the angle of the seatback.

The main controller may further receive information regarding whether or not an air conditioning system is on or off and adjust one of the temperature of the operation stage or the plurality of operation stage-specific operation temperatures of each of the warmers according to whether or not the air conditioning system is on or off.

When the air conditioning system is on, the main controller may adjust one of the temperature of the operation stage or the plurality of operation stage-specific operation temperatures of each of the warmers to a lower temperature according to a duration that the air conditioning system is on.

When the air conditioning system is off, the main controller may adjust one of the temperature of the operation stage or the plurality of operation stage-specific operation temperatures of each of the warmers to a lower temperature according to a duration that the air conditioning system is on by delaying the adjustment in comparison to when the air conditioning system is on.

The main controller may further receive information regarding whether or not a door is opened, and when the door is opened, may adjust one of the temperature of the operation stage or the plurality of operation stage-specific operation temperatures of each of the warmers to a lower temperature.

When the door is closed after being opened, the main controller may control one of the temperature of the operation stage or the plurality of operation stage-specific operation temperatures of the warmer to be higher than one of the temperature of the operation stage or the plurality of operation stage-specific operation temperatures before the door is opened.

The main controller may further receive information regarding whether or not a mobility vehicle has been involved in a collision and, when it is determined that there is a collision involving the mobility vehicle, control all of the warmers to be off.

When a warmer is determined to not operate at one of the temperature of the operation stage or the plurality of operation stage-specific operation temperatures input through the main controller, the corresponding sub-controller may transmit an abnormality signal to the main controller. When the abnormality signal is input, the main controller may notify abnormal operation of the warmer using a warning system.

According to another embodiment of the present disclosure, also provided is an integrated warmer control method including reviewing, by a main controller, situation-specific information according to a situation of an occupant and a mobility vehicle, deriving, by the main controller, one of the temperature of the operation stage or the plurality of operation stage-specific operation temperatures of each of the warmers according to the situation-specific information, and transmitting one of the temperature of the operation stage or the plurality of operation stage-specific operation temperatures of each of the warmers derived by the main controller to a plurality of sub-controllers and operating, by the sub-controllers, the warmers, respectively.

The integrated warmer control method may further include receiving, by the main controller, a command for operating the warmers from the occupant before reviewing the situation-specific information.

The integrated warmer control system having the above-described configuration may allow a plurality of warmers provided inside a mobility vehicle to operate at different temperatures so as to efficiently provide warming heat through the warmers, thereby improving occupant comfort.

In addition, the temperatures of the plurality of warmers are subdivided according to the position of a seat and the posture of an occupant. When a command is input through the integrated switch, the temperature of each of the warmers may be adjusted, so that optimized warming may be performed.

### BRIEF DESCRIPTION OF THE DRAWINGS

The above and other objectives, features, and other advantages of embodiments of the present disclosure will be more clearly understood from the following detailed description when taken in conjunction with the accompanying drawings, in which:

FIG. 1 is a block diagram illustrating a configuration of an integrated warmer control system according to an embodiment of the present disclosure;

FIG. 2 is a table illustrating operation stages of the integrated warmer control system illustrated in FIG. 1;

FIG. 3 is a perspective diagram illustrating the warmer devices according to an embodiment of the present disclosure;

FIGS. 4A and 4B are diagrams illustrating warmer control in a sleep mode by the integrated warmer control system illustrated in FIG. 1;

FIGS. 5A and 5B are diagrams illustrating warmer control in a facing mode by the integrated warmer control system illustrated in FIG. 1;

FIGS. 6A and 6B are diagrams illustrating warmer control according to the position of the seat by the integrated warmer control system illustrated in FIG. 1;

FIGS. 7A and 7B are diagrams illustrating warmer control according to the position of the seatback by the integrated warmer control system illustrated in FIG. 1;

FIGS. 8A and 8B are diagrams illustrating warmer control according to on/off of an air conditioning system by the integrated warmer control system illustrated in FIG. 1;

FIGS. 9A and 9B are diagrams illustrating warmer control according to opening/closing of a door by the integrated warmer control system illustrated in FIG. 1;

FIGS. 10A and 10B are diagrams illustrating warmer control according to a collision by the integrated warmer control system illustrated in FIG. 1; and

FIG. 11 is a flowchart illustrating an integrated warmer control method according to embodiments of the present disclosure.

### DETAILED DESCRIPTION OF ILLUSTRATIVE EMBODIMENTS

Hereinafter, embodiments disclosed in the present disclosure will be described in detail with reference to the accompanying drawings, in which identical or similar constituent elements are given the same reference numerals throughout the drawings, and a repeated description thereof will be omitted.

The terms “module” and “part” used in the following description are given or combined only considering the ease of creating the specification and have no meanings or roles that are distinguished from each other by themselves.

In the description of embodiments of the present disclosure, when it is determined that the detailed description of the related art would obscure the gist of the embodiments of the present disclosure, the detailed description thereof will be omitted. In addition, the attached drawings are merely intended to aid a person of ordinary skill in the art to readily understand the embodiments disclosed herein, and thus the technical ideas disclosed herein are not limited by the attached drawings, and the embodiments should be understood to include all changes, equivalents, and substitutions included in the idea and technical scope of embodiments of the present disclosure.

It will be understood that, although the terms “first,” “second,” etc., may be used herein to describe various elements, these elements should not be limited by these terms. These terms are only used to distinguish one element from another element.

It will be understood that when an element is referred to as being “coupled,” “connected,” or “linked” to another element, it can be directly coupled or connected to the other element or intervening elements may be present therebetween. In contrast, it should be understood that when an element is referred to as being “directly coupled,” “directly connected,” or “directly linked” to another element, there are no intervening elements present.

As used herein, singular forms such as “a,” “an,” and “the” are intended to include the plural forms as well, unless the context clearly indicates otherwise.

It will be further understood that the terms “comprise,” “include,” “have,” etc., when used in this specification, specify the presence of stated features, integers, steps, operations, elements, components, and/or combinations thereof but do not preclude the presence or addition of one or more other features, integers, steps, operations, elements, components, and/or combinations thereof.

A controller according to an embodiment disclosed in this specification may include a communication device communicating with another controller or a sensor in order to control a function which the controller manages, a memory storing an operating system, logic instructions, input/output information, and the like, and one or more processors performing a determination, calculation, decision, and the like necessary for controlling the function.

Hereinafter, an integrated warmer control system according to exemplary embodiments of the present disclosure will be described with reference to the accompanying drawings.

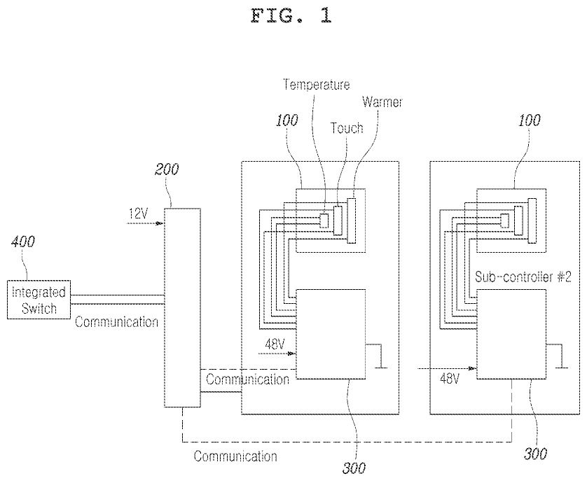

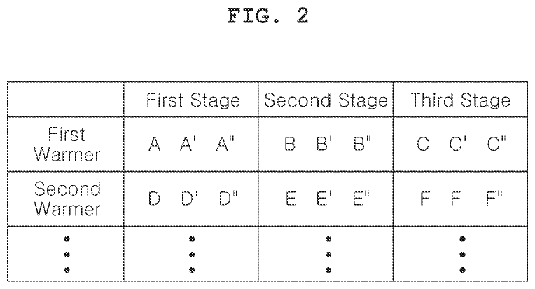

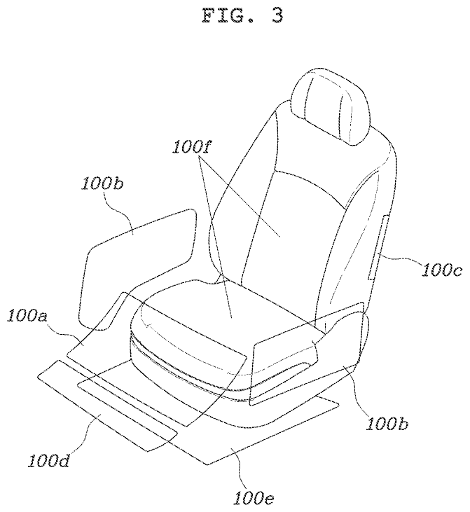

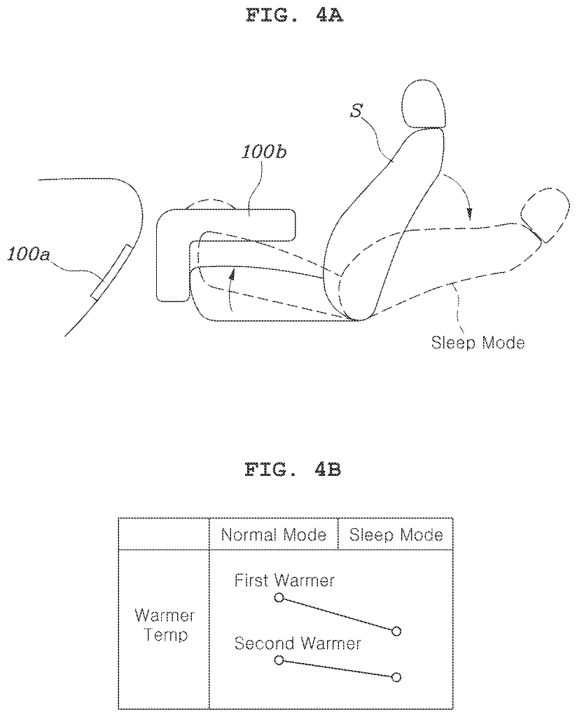

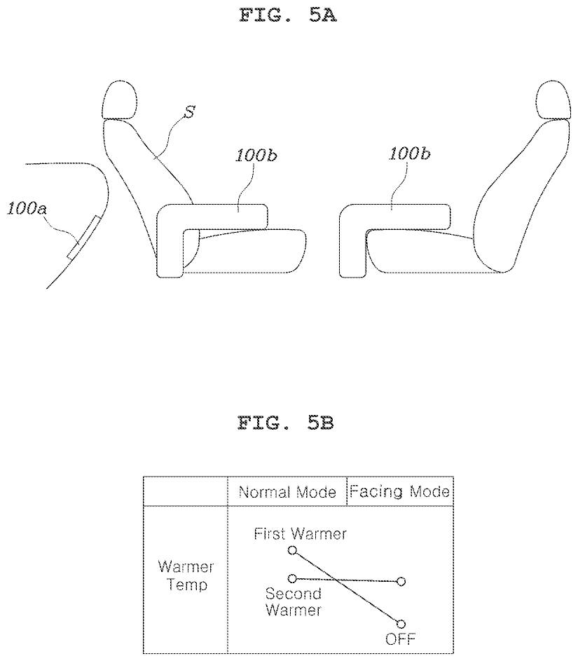

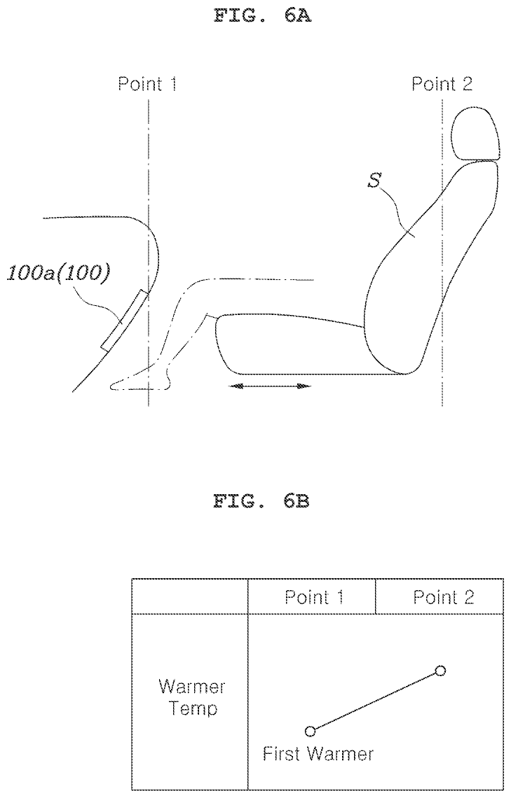

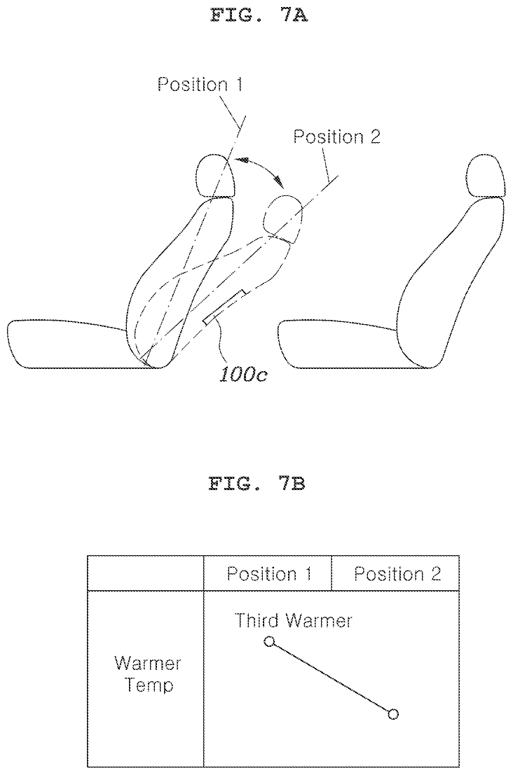

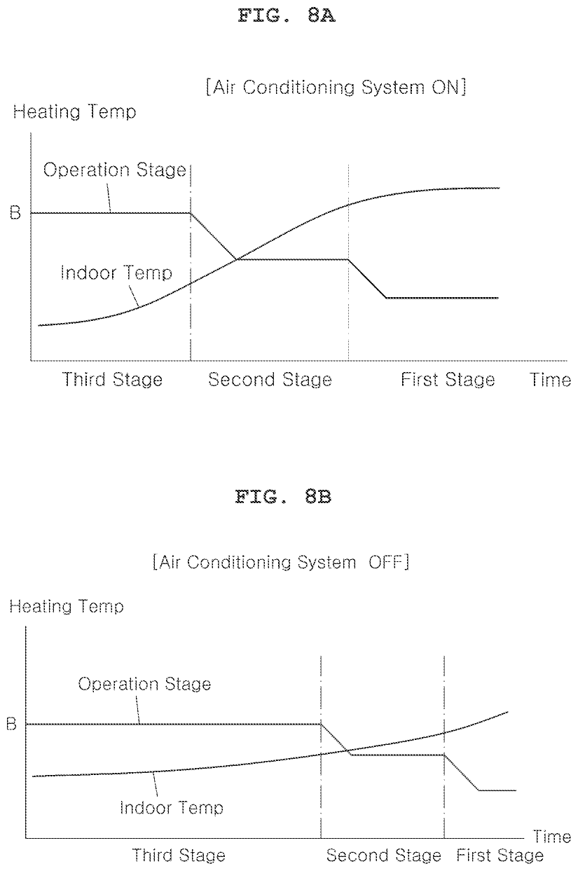

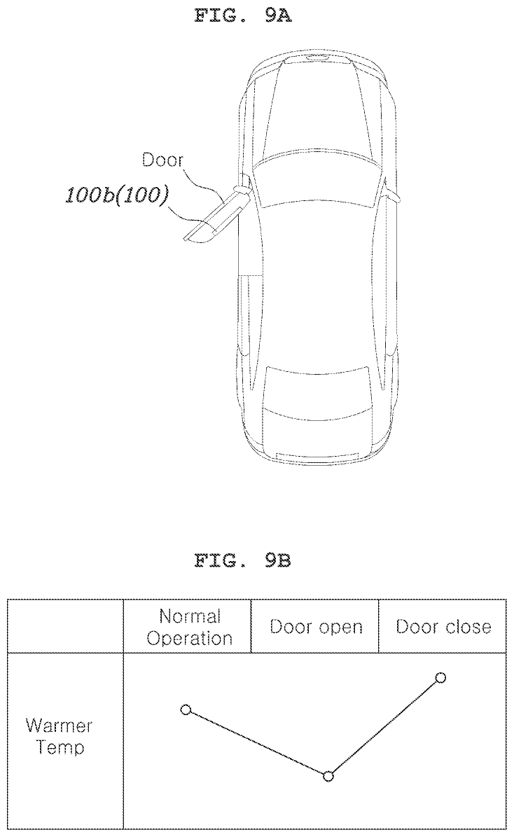

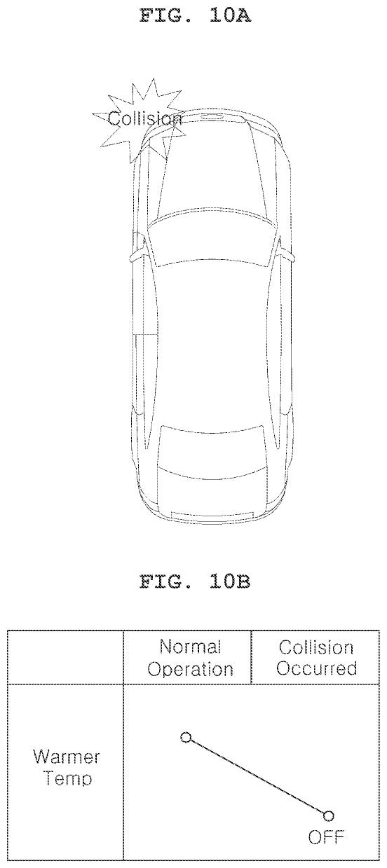

FIG. 1 is a block diagram illustrating a configuration of an integrated warmer control system according to an embodiment of the present disclosure, FIG. 2 is a table illustrating operation stages of the integrated warmer control system illustrated in FIG. 1, FIG. 3 is a perspective diagram illustrating the warmer devices according to an embodiment of the present disclosure, FIGS. 4A and 4B are diagrams illustrating warmer control in a sleep mode by the integrated warmer control system illustrated in FIG. 1, FIGS. 5A and 5B are diagrams illustrating warmer control in a facing mode by the integrated warmer control system illustrated in FIG. 1, FIGS. 6A and 6B are diagrams illustrating warmer control according to the position of the seat by the integrated warmer control system illustrated in FIG. 1, FIGS. 7A and 7B are diagrams illustrating warmer control according to the position of the seatback by the integrated warmer control system illustrated in FIG. 1, FIGS. 8A and 8B are diagrams illustrating warmer control according to on/off of an air conditioning system by the integrated warmer control system illustrated in FIG. 1, FIGS. 9A and 9B are diagrams illustrating warmer control according to opening/closing of a door by the integrated warmer control system illustrated in FIG. 1, and FIGS. 10A and 10B are diagrams illustrating warmer control according to a collision by the integrated warmer control system illustrated in FIG. 1.

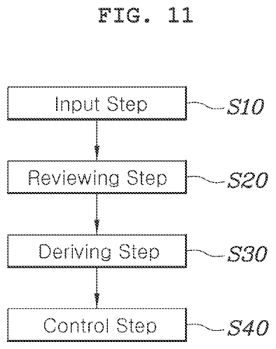

FIG. 11 is a flowchart illustrating an integrated warmer control method according to embodiments of the present disclosure.

As illustrated in FIG. 1, the integrated warmer control system according to embodiments of the present disclosure includes a plurality of warmers 100 disposed in and around a seat S, a main controller 200 deriving a command signal according to one of the temperature of an operation stage or a plurality of operation stage-specific operation temperatures (i.e., operation temperatures according to the operation stage) of each of the warmers 100, on the basis of situation-specific information, and a plurality of sub-controllers 300 provided on the plurality of warmers 100, respectively, to control the plurality of warmers 100. The plurality of sub-controllers 300 may receive the command signal according to the derived one of the temperature of the operation stage or the plurality of operation stage-specific operation temperatures through communication with the main controller 200 and control the warmers 100 to operate in response to the input command signal.

In embodiments of the present disclosure, in the plurality of warmers 100 provided in the interior of a vehicle, the main controller 200 derives the command signal according to one of the temperature of the operation stage or the plurality of operation stage-specific operation temperatures of each warmer 100 and transmits the command signal according to one of the temperature of the operation stage or the plurality of operation stage-specific operation temperatures to the sub-controllers 300 to control the warmers 100, respectively, using the command signal. Each of the sub-controllers 300 controls the corresponding warmer 100 at the received one of the temperature of the received operation stage or the plurality of operation stage-specific operation temperatures. Consequently, the plurality of warmers 100 may operate at different temperatures. As each of the warmers 100 operates at one of the temperature in the operation stage or the plurality of operation stage-specific operation temperatures derived on the basis of situation-specific information, air-conditioning comfort of an occupant seated in the seat S is improved.

That is, in the related art, even in the case that a plurality of warmers are provided in the interior of a vehicle, the plurality of warmers have not been efficiently operated, since the warmers are manipulated and controlled respectively or all of the warmers are simultaneously on/off controlled.

In contrast, according to embodiments of the present disclosure, the main controller 200 receives the situation-specific information regarding whether the air conditioning is on or off, whether a door is opened or not, the position of the seat, the posture of the occupant, whether or not a collision has occurred, a required temperature, and the like, and derives an optimized one of the temperature of the operation stage or the plurality of operation stage-specific operation temperatures, so that the plurality of warmers 100 may be operated at different temperatures. In addition, since the main controller 200 and the sub-controllers 300 are configured to transmit and receive signals via wireless communications, electrical lines through which the plurality of warmers 100 are connected to the single main controller 200 are omitted. Thus, the plurality of warmers 100 may be efficiently operated.

Here, the plurality of sub-controllers 300 may be provided in the plurality of warmers 100, respectively. In this manner, the sub-controllers 300 are provided in the plurality of warmers 100, respectively, and each of the sub-controllers 300 receives the command signal according to one of the temperature of the operation stage or the plurality of operation stage-specific operation temperatures optimized for the corresponding warmer 100 through wireless communication with the main controller 200. Thus, no separate wires for connection to the main controller 200 are required.

In addition, some warmers 100 of the plurality of warmers 100 may be grouped, and the sub-controllers 300 may be provided according to the group. That is, according to an embodiment of the present disclosure, since a plurality of warmers 100 are provided, some adjacently disposed warmers 100 may be grouped, and the sub-controllers 300 may be allocated to respective groups. In this manner, the main controller 200 may transfer the command signal according to one of the temperature of the operation stage or the plurality of operation stage-specific operation temperatures of each of the warmers 100 to the corresponding sub-controller 300, and the sub-controllers 300 may control the heating operation of the warmers 100 of the groups, respectively.

As described above, each of the sub-controllers 300 may receive the command signal according to one of the temperature of the operation stage or the plurality of operation stage-specific operation temperatures from the main controller 200 and control the corresponding warmer 100 to operate according to the received command signal.

Describing embodiments of the present disclosure in detail, the warmers 100 according to an embodiment of the present disclosure may have a variety of configurations. For example, the warmers 100 may be configured to provide warming heat to the lower body of an occupant from the front of the seat S, provide warming heat to the feet of the occupant from below the front of the seat S, provide warming heat to the upper body or the lower body of the occupant from a side of the seat S, or provide warming heat upward from below the seat S.

The warmers 100 may be selectively used in a mobility vehicle and may be connected to the sub-controllers 300, respectively, to be operated under the control of the sub-controllers 300.

In particular, in embodiments of the present disclosure, the main controller 200 and the sub-controllers 300 are provided to control the warmers 100.

Here, the main controller 200 has one of the temperature of the operation stage or the plurality of operation stage-specific operation temperatures of each of the warmers 100 stored in a database and adjusts one of the temperature of the operation stage or the plurality of operation stage-specific operation temperatures of each of the warmers 100 according to the situation-specific information regarding whether air conditioning is on or off, whether the door is opened or not, the position of the seat, the posture of the occupant, whether or not a collision has occurred, a required temperature, and the like. In this manner, the main controller 200 controls each of the warmers 100 to operate at a temperature at which optimal warming heat may be provided according to the situation by adjusting and deriving one of the temperature of the operation stage or the plurality of operation stage-specific operation temperatures of each of the warmers 100 stored in the database according to a variety of situations.

Specifically, the main controller 200 may have one of the temperature of the operation stage or the plurality of operation stage-specific operation temperatures stored differently according to each of the warmers 100.

That is, as warming heat is provided to different portions of the occupant according to positions at which the plurality of warmers 100 are disposed, the main controller 200 differently sets one of the temperature of the operation stage or the plurality of operation stage-specific operation temperatures according to each of the warmers 100.

According to an embodiment of the present disclosure, as illustrated in FIG. 3, the warmers 100 may include a first warmer low disposed on a front portion of the seat, second warmers 100b disposed on side portions of the seat, and a third warmer 100c disposed on a seatback to provide heat backward to the lower body of an occupant seated in a rear seat. The warmers 100 may further include a fourth warmer 100d disposed in front of the seat to provide heat to the feet of the occupant, a fifth warmer 100e configured to provide heat upward from below the seat, and seat hot wires 100f. The warmers 100 may be further added depending on the positions at which heat is to be provided to the occupant seated in the seat. Respective warmers 100 may operate differently according to one of the temperature of the operation stage or the plurality of operation stage-specific operation temperatures derived by the main controller 200.

For example, the first warmer 100a provided in front of the seat S is more spaced apart from the occupant than the second warmers 100b provided on sides of the seat S. Thus, even in the case that the first warmer 100a and the second warmers 100b operate in the first operation stage in the same situation, the operation temperature of the first warmer 100a may be set to be higher than the operation temperature of the second warmers 100b in the same first operation stage.

Accordingly, the plurality of warmers 100 may provide optimal warming heat in a variety of situations.

Specifically, one of the temperature of the operation stage or the plurality of operation stage-specific operation temperatures of each of the warmers 100 derived by the main controller 200 may be adjusted according to the situation, and thus the temperature of each of the warmers 100 may be controlled precisely.

For example, as illustrated in FIG. 2, the operation stages of the warmers boo are divided into a first stage, a second stage, and a third stage, and a plurality of operation stage-specific operation temperatures are set.

That is, in a state in which each of the warmers 100 operates in the first stage in response to manipulation of the occupant or depending on a predetermined temperature condition, when the situation-specific information regarding whether air conditioning is on or off, whether a door is opened or not, the position of the seat, whether or not the posture of the occupant has changed, whether or not a collision has occurred, a required temperature, and the like is input, the main controller 200 derives the optimized temperature of the operation stage or one of the plurality of operation stage-specific operation temperatures of each of the warmers wo, on the basis of the input situation-specific information.

For example, the first warmer 100a is provided in front of the seat, and the second warmers 100b are provided on sides of the seat. The first warmer 100a is set so that the operation stage is the first stage and the operation temperature is A′. The second warmers 100b are set so that the operation stage is the first stage and the operation temperature is D′. When the seat is moved forward, the distance between the occupant seated in the seat and the first warmer 100a decreases. Then, the main controller 200 maintains the first operation stage and, in this state, adjusts the operation temperature to be A which is lower than A′ among the plurality of operation temperatures of the first operation stage. In addition, in the case of the second warmers 100b, even in the case that the seat has moved forward, there are no changes in the distances between the occupant and the second warmers 100b, thus the main controller 200 maintains the first operation stage and the operation temperature D′.

In this manner, in embodiments of the present disclosure, as the main controller 200 subdivides and adjusts the operation stage and the plurality of operation stage-specific operation temperatures of each of the warmers 100, the temperature of each of the warmers 100 may be precisely controlled through stepwise changes in temperature according to a variety of situations, and each of the warmers 100 may efficiently provide warming heat. In addition, the above-described main controller 200 may perform control so that when the plurality of operation stage-specific operation temperatures of each of the warmers 100 reaches the highest temperature in the corresponding operation stage, the operation stage is changed.

The plurality of operation stage-specific operation temperatures of each of the warmers 100 may be set differently according to each of the warmers 100. For example, in case of the first warmer 100a, in the first operation stage, the operation temperatures A, A′, and A″ may be set to be 30°, 33°, and 36°, respectively. In the second operation stage, the operation temperatures B, B′, and B″ may be set to be 39°, 43°, and 46°, respectively. In addition, in the first operation stage, the operation temperatures D, D′, and D″ may be set to be 25°, 28°, and 31°, respectively. In the second operation stage, the operation temperatures E, E′, and E″ may be set to be 34°, 37°, and 40°, respectively.

The operation stage or the plurality of operation stage-specific operation temperatures of each of the warmers 100 and the operation stage-specific operation temperatures adjusted according to the situation may be previously stored in the database of the main controller 200. Thus, a variety of set values may be provided according to the performance and the design position of the warmer 100.

In addition, when a user command is input through an integrated switch 400, the main controller 200 may derive one of the temperature of the operation stage or the plurality of operation stage-specific operation temperatures of each of the warmers 100 and transmit the command signal according to the derived one of the temperature of the operation stage or the plurality of operation stage-specific operation temperatures to the corresponding sub-controller 300.

As described above, according to embodiments of the present disclosure, the operation stage of each of the warmers 100 is controlled through the integrated switch 400. The main controller 200 derives one of the temperature of the operation stage or the plurality of operation stage-specific operation temperatures of each of the warmers 100 according to the situation-specific information when the integrated switch 400 is manipulated and transmits the command signal to each of the sub-controllers 300 so that each of the warmers 100 operates at the derived one of the temperature of the operation stage or the plurality of operation stage-specific operation temperatures.

For example, when the user selects an operation stage by controlling the integrated switch 400, the main controller 200 derives one of the temperature of the operation stage or the plurality of operation stage-specific operation temperatures of each of the warmers 100 by collecting the selected operation stage and the situation-specific information. That is, in a situation in which the operation stage is determined by manipulation of the integrated switch 400, when the user inputs a command to lower the temperature of the air conditioning, the temperature of each of the warmers 100 is derived by reselecting one of the plurality of operation stage-specific operation temperatures in the operation stage set by the user according to the situation-specific information changed to lower the temperature of the air conditioning.

In this manner, one of the temperature of the operation stage or the plurality of operation stage-specific operation temperatures derived by the main controller 200 is transmitted to the sub-controllers 300, and each of the sub-controllers 300 controls the corresponding warmer 100 to operate at one of the temperature of the operation stage or the plurality of operation stage-specific operation temperatures.

Here, in the case of the sub-controllers 300, one of the temperature of the operation stage or the plurality of operation stage-specific operation temperatures according to the situation transmitted by the main controller 200 may be memorized, and the same control may be performed later in the same environment.

In addition, the main controller 200, the sub-controllers 300, and the warmers 100 according to an embodiment of the present disclosure are configured to efficiently transmit and receive power and signals.

Specifically, connection lines through which temperature information, contact information, and power are transmitted may be electrically connected to each of the sub-controllers 300. The sub-controllers 300 may receive power from an external source and wirelessly communicate with the main controller 200.

That is, each of the warmers 100 may be provided with a temperature sensor for checking warming heat and a touch sensor for detecting whether or not an occupant or an object comes into contact with the warmer 100 and may be configured to receive power.

Each of the warmers 100 is provided with wires through which the temperature sensor, the touch sensor, and power are electrically connected. Since the plurality of warmers 100 are provided, when the wires of each of the warmers 100 are directly connected to the main controller 200 without the sub-controllers 300, an excessively large number of wires may be connected to the main controller 200, thereby causing problems such as an increase in weight and a voltage drop.

In this regard, according to embodiments of the present disclosure, each of the sub-controllers 300 is electrically connected to the corresponding warmer 100 through wires, and the sub-controllers 300 wirelessly communicate with the main controller 200. As a result, the wires connected to the warmers 100 are simplified, thereby facilitating the provision of the warmers 100.

In addition, since the warmers 100 may be set to have different sizes and resistance values, each of the sub-controllers 300 is provided on the corresponding warmer 100, thereby facilitating the adjustment of one of the temperature of the operation stage or the plurality of operation stage-specific operation temperatures.

As described above, according to embodiments of the present disclosure, by providing the main controller 200 as a common controller and separately providing the warmers 100 and the sub-controllers 300, the number of the warmers 100 may be freely determined.

Hereinafter, the above-described control according to embodiments of the present disclosure will be described.

In embodiments of the present disclosure, the main controller 200 may receive the situation-specific information and derive one of the temperature of the operation stage or the plurality of operation stage-specific operation temperatures of each of the warmers 100 on the basis of the situation-specific information.

The situation-specific information may include whether the air conditioning is on or off, whether a door is opened or not, the position of the seat, the posture of the occupant, whether or not a collision has occurred, a required temperature, and the like.

Here, the position of the seat may be input using a seat position sensor, and information regarding the posture of the occupant may be obtained according to the positions of the seat cushion and the seatback. In addition, the posture of the occupant may be reviewed using an indoor camera sensor, an ultrasonic sensor, a laser sensor, and the like. Not only information regarding the posture of the occupant but also information regarding the distance between occupants may be obtained using at least one of the sensors.

According to an embodiment of the present disclosure, the main controller 200 derives one of the temperature of the operation stage or the plurality of operation stage-specific operation temperatures of each of the warmers 100 provided around the seat S on the basis of the situation-specific information and transmits a command signal according to the derived one of the temperature of the operation stage or the plurality of operation stage-specific operation temperatures to the sub-controllers 300, so that each of the warmers 100 operates at one of the temperature of the operation stage or the plurality of operation stage-specific operation temperatures.

Specifically, as illustrated in FIGS. 4A and 4B, the warmers 100 may include the first warmer 100a providing heat to the lower body of the occupant from in front of the seat S and a second warmer 100b providing heat to the lower body of the occupant from a side of the seat S. Here, the first warmer 100a may be disposed on a dashboard side, and the second warmer 100b may be disposed on a door side of the interior. The first warmer 100a and the second warmer 100b may be configured to provide warming heat to the occupant by radiating heat.

Accordingly, when the seat S is converted into a sleep mode, the main controller 200 adjusts current one of the temperature of the operation stage or the plurality of operation stage-specific operation temperatures of each of the first warmer 100a and the second warmer 100b to a lower temperature according to the position of the seat in the sleep mode.

The sleep mode of the seat S may be a state in which the seatback is reclined backward and the occupant is in the lying posture. In the sleep mode, the lower body of the occupant is lifted and moved to be closer to the first warmer 100a, thereby increasing the surface area facing the second warmer 100b.

Accordingly, when the seat S is converted into the sleep mode, the main controller 200 derives one of the temperature of the operation stage or the plurality of operation stage-specific operation temperatures of each of the first warmer 100a and the second warmer 100b on the basis of the information previously stored in the database. Here, the main controller 200 adjusts one of the temperature of the operation stage or the plurality of operation stage-specific operation temperatures of each of the first warmer 100a and the second warmer 100b to be lower than one of the temperature of the operation stage or the plurality of operation stage-specific operation temperatures before the sleep mode, thereby lowering the temperature of heat generated by the first warmer 100a and the second warmer 100b.

That is, as the lower body of the occupant moves to be closer to the first warmer 100a in the sleep mode, one of the temperature of the operation stage or the plurality of operation stage-specific operation temperatures of the first warmer 100a may be lowered so that warming heat may be reliably provided to the occupant.

In addition, as illustrated in FIGS. 5A and 5B, when the seat S is converted to a facing mode to face a rear seat, the main controller 200 controls the first warmer 100a to be off and the second warmers 100b to maintain one of the temperature of the operation stage or the plurality of operation stage-specific operation temperatures.

In the facing mode, the seat S is turned 180° to face the rear seat. The first warmer bow is turned off, since there is no object to which warming heat is to be provided even in the case that the first warmer 100a operates. Since the occupant of the seat S is within the radius in which warming heat is provided by the second warmer 100b of the seat S, one of the temperature of the operation stage or the plurality of operation stage-specific operation temperatures of the second warmer 100b of the seat S is maintained.

As described above, in the facing mode, it is possible to provide warming heat to the occupant while stopping the unnecessary operation of the warmer 100a to reduce energy consumption.

In addition, as illustrated in FIGS. 6A and 6B, when the seat S moves toward the first warmer 100a provided in front thereof, the main controller 200 adjusts one of the temperature of the operation stage or the plurality of operation stage-specific operation temperatures of the first warmer 100a to a lower temperature according to the distance of forward movement of the seat S. When the seat S moves away from the first warmer 100a, the main controller 200 adjusts one of the temperature of the operation stage or the plurality of operation stage-specific operation temperatures of the first warmer 100a to a higher temperature according to the distance of backward movement of the seat S.

That is, when the seat S moves forward, the occupant is moved closer to the first warmer 100a and thus may be burned by warming heat generated by the first warmer 100a. When the seat S moves backwards, the occupant is moved away from the first warmer 100a and thus warming heat may not be properly supplied to the occupant.

Thus, as illustrated in FIGS. 6A and 6B, when the seat moves toward Point 1 in a direction closer to the first warmer 100a, the main controller 200 adjusts one of the temperature of the operation stage or the plurality of operation stage-specific operation temperatures of the first warmer 100a to a lower temperature according to the distance of movement toward Point 1. In this manner, the main controller 200 may perform subdivided temperature control according to the distance between the seat S and the first warmer 100a by adjusting one of the temperature of the operation stage or the plurality of operation stage-specific operation temperatures of the first warmer 100a to a lower temperature according to the distance by which the seat S is moved forward to be closer to the first warmer 100a, thereby providing optimized warming heat from the first warmer 100a.

In addition, when the seat S is moved toward Point 2 in a direction away from the first warmer 100a, the main controller 200 adjusts one of the temperature of the operation stage or the plurality of operation stage-specific operation temperatures of the first warmer 100a to a higher temperature according to the distance of movement toward Point 2. In this manner, the main controller 200 may perform subdivided temperature control according to the distance between the seat S and the first warmer 100a by adjusting one of the temperature of the operation stage or the plurality of operation stage-specific operation temperatures of the first warmer 100a to a higher temperature, thereby providing optimized warming heat from the first warmer 100a.

In addition, as illustrated in FIGS. 7A and 7B, the warmers 100 include the third warmer 100c provided on the seatback of the seat S to provide heat to the lower body of a rear seat occupant, i.e., an occupant seated in a seat behind the seat S. When the seat S is moved backwards or the angle of the seatback is adjusted backward, the main controller 200 adjusts a predetermined temperature of the third warmer 100c, i.e., one of the temperature of the operation stage or the plurality of operation stage-specific operation temperatures of the third warmer 100c, to a lower temperature.

In particular, when the seat S is moved backwards or the angle of the seatback is adjusted backward, the main controller 200 adjusts one of the temperature of the operation stage or the plurality of operation stage-specific operation temperatures of the third warmer 100c to a lower temperature as the distance between the third warmer 100c and the rear seat occupant decreases. Here, the main controller 200 may perform subdivided temperature control according to the distance between the third warmer 100c and the rear seat occupant by gradually adjusting the operation temperature in the current operation stage of the third warmer 100c to a lower temperature according to the distance by which the seat S is moved backwards or the third warmer 100c is closer to the occupant due to backward reclining of the seatback.

In addition, the main controller 200 may further receive information regarding whether or not an air conditioning system is on or off and adjust a predetermined temperature, i.e., one of the temperature of the operation stage or the plurality of operation stage-specific operation temperatures, of each of the warmers 100 according to whether or not the air conditioning system is on or off.

Specifically, as illustrated in FIG. 8A, when the air conditioning system is on, the main controller 200 adjusts the predetermined temperature, i.e., one of the temperature of the operation stage or the plurality of operation stage-specific operation temperatures, of each of the warmers 100 to a lower temperature according to the duration that the air conditioning system has been on.

That is, when the air conditioning system is on, warming air is provided to the interior to increase the indoor temperature. Then, the occupant may feel warming heat due to the operation of the warmers boo to be excessive. Thus, when the air conditioning system is on, the main controller 200 may adjust the predetermined temperature, i.e., one of the temperature of the operation stage or the plurality of operation stage-specific operation temperatures, of each of the warmers 100 to a lower temperature and gradually adjust the operation temperature of the operation stage of each of the warmers 100 to a lower temperature by considering that the indoor temperature increases according to the duration that the air conditioning system has been on after the air conditioning system is on.

In addition, in a state in which the air conditioning system is on, the main controller 200 may adjust one of the temperature of the operation stage or the plurality of operation stage-specific operation temperatures of each of the warmers 100 according to the set value of a target temperature of air conditioning. In this manner, according to embodiments of the present disclosure, one of the temperature of the operation stage or the plurality of operation stage-specific operation temperatures of each of the warmers 100 may be adjusted in concert with indoor air conditioning, thereby further obtaining occupant comfort.

In addition, as illustrated in FIG. 8B, when the air conditioning system is off, the main controller 200 adjusts one of the temperature of the operation stage or the plurality of operation stage-specific operation temperatures of each of the warmers 100 to a lower temperature according to the duration that the air conditioning system has been on, in particular, by further delaying the adjustment in comparison to when the air conditioning system is on.

That is, when the air conditioning system is off, the air conditioning system is not used by reflecting the intention of the occupant, and no warming air is supplied to the interior. Here, the main controller 200 adjusts one of the temperature of the operation stage or the plurality of operation stage-specific operation temperatures of each of the warmers 100 to a lower temperature and delays a point in time of the adjustment in concert with turning off of the air conditioning system, thereby allowing the feeling of warmth to be maintained for a predetermined time. Consequently, even in the case that the air conditioning system is off, a sudden change in temperature is prevented, and thus air conditioning satisfaction of the user is improved.

In addition, as illustrated in FIGS. 9A and 9B, the main controller 200 further receives information regarding whether or not the door is opened, and when the door is opened, adjusts the predetermined temperature, i.e., one of the temperature of the operation stage or the plurality of operation stage-specific operation temperatures, of each of the warmers 100 to a lower temperature.

Here, the warmers 100 are the second warmers 100b providing heat to the lower body of the occupant from sides of the seat S, one of which may be disposed on the door.

In particular, when the door is opened, the warmer 100b is moved outdoors and away from the target to which warming heat is to be provided. Thus, when the door is determined to be opened, the predetermined temperature, i.e., one of the temperature of the operation stage or the plurality of operation stage-specific operation temperatures, of the second warmers 100b is adjusted to a lower temperature in order to prevent unnecessary energy consumption. Here, although the main controller 200 may control the second warmers 100b to be off, one of the temperature of the operation stage or the plurality of operation stage-specific operation temperatures of the second warmers 100b is adjusted to a lower temperature, since the door is not generally maintained in the opened position.

In addition, when the door is closed after being opened, the main controller 200 controls one of the temperature of the operation stage or the plurality of operation stage-specific operation temperatures of the warmers 100b to be higher than one of the temperature of the operation stage or the plurality of operation stage-specific operation temperatures before the door is opened.

That is, when the door is opened, cold outside air enters the interior, thereby lowering the indoor temperature. Thus, when the door is closed after being opened, the main controller 200 adjusts one of the temperature of the operation stage or the plurality of operation stage-specific operation temperatures of the warmer 100 to be higher than the temperature before the door is opened, thereby allowing the occupant to rapidly feel warmth.

Afterwards, when a predetermined time has passed after the door is closed, the main controller 200 may control one of the temperature of the operation stage or the plurality of operation stage-specific operation temperatures of the warmer 100b to be a previous temperature.

In addition, as illustrated in FIGS. 10A and 10B, the main controller 200 further receives information regarding whether or not a mobility vehicle has collided and, when it is determined that there is a collision in the mobility vehicle, controls all of the warmers 100 to be off.

That is, when it is determined that there is a collision in the mobility vehicle using a LiDAR sensor, a camera, a laser, and the like provided in the mobility vehicle, the main controller 200 may control all of the warmers 100 to be off, thereby preventing secondary damage due to the operation of the warmers 100 after the collision.

In addition, when a warmer 100 is determined to not operate at one of the temperature of the operation stage or the plurality of operation stage-specific operation temperatures input through the main controller 200, the corresponding sub-controller 300 transmits an abnormality signal to the main controller 200. When the abnormality signal is input, the main controller 200 provides notification of the abnormal operation of the warmer using a warning system.

That is, each of the sub-controllers 300 controls the corresponding warmer 100 at one of the temperature of the operation stage or the plurality of operation stage-specific operation temperatures input through the main controller 200. Here, when the warmer 100 malfunctions or stops or does not operate at one of the temperature of the operation stage or the plurality of operation stage-specific operation temperatures, each of the sub-controllers 300 may determine that the corresponding warmer 100 is abnormal.

In this manner, when one of the warmers 100 controlling the operation is determined to be abnormal, the corresponding sub-controller 300 may transfer an abnormality signal indicating the abnormality of the corresponding warmer 100 to the main controller 200. The main controller 200 may receive the abnormality signal indicating the abnormality of the corresponding warmer 100 and generate a light signal or warning sound using the warning system to notify the occupant about the abnormality of the warmer 100. Here, the warning system may be the cluster, an AVN device, an indoor display, and the like. Notification of the abnormality of the warmer 100 through the warning system allows the warmer 100 to be diagnosed and repaired.

In addition, as illustrated in FIG. 11, an integrated warmer control method according to embodiments of the present disclosure includes a reviewing step S20 of reviewing, by the main controller 200, situation-specific information according to the situation of an occupant and a mobility vehicle, a deriving step S30 of deriving, by the main controller 200, one of the temperature of the operation stage or the plurality of operation stage-specific operation temperatures of each of the warmers 100 according to the situation-specific information, and a control step S40 of transmitting one of the temperature of the operation stage or the plurality of operation stage-specific operation temperatures of each of the warmers 100 derived by the main controller 200 to the sub-controllers 300 and operating, by the sub-controllers 300, the warmers 100, respectively.

Here, the integrated warmer control method may further include an input step S10 of receiving, by the main controller 200, a command for operating the warmers 100 from the occupant before the reviewing step S20.

In the input step S10, the command by the occupant includes information regarding whether or not to operate the warmers 100 and the air conditioning system.

Afterwards, in the reviewing step S20, the situation-specific information according to the situation of the occupant and the mobility vehicle is reviewed. Here, the situation-specific information may include whether the air conditioning is on or off, whether a door is opened or not, the position of the seat, the posture of the occupant, whether or not a collision has occurred, a required temperature, and the like.

In this manner, when the command by the occupant and the situation-specific information are reviewed, one of the temperature of the operation stage or the plurality of operation stage-specific operation temperatures of each of the warmers 100 is derived in the deriving step S30. That is, an optimized temperature, i.e., one of the temperature of the operation stage or the plurality of operation stage-specific operation temperatures, of each of the warmers 100 is derived on the basis of the input information, so that the plurality of warmers 100 may operate at different temperatures. Accordingly, in the deriving step S30, the main controller 200 may set one of the temperature of the operation stage or the plurality of operation stage-specific operation temperatures of each of the warmers 100 and thus perform precise temperature control according to the situation.

As set forth above, the main controller 200 derives one of the temperature of the operation stage or the plurality of operation stage-specific operation temperatures of each of the warmers 100 through the input step S10, the reviewing step S20, and the deriving step S30 and transmits the command according to the derived temperature, i.e., one of the temperature of the operation stage or the plurality of operation stage-specific operation temperatures, to the corresponding sub-controller 300. Accordingly, each of the plurality of sub-controllers 300 controls the corresponding warmer 100 to operate according to the input command, so that the plurality of warmers may operate at different temperatures. It is possible to efficiently provide warming heat through respective warmers, thereby improving occupant comfort.

In addition, the temperatures of the plurality of warmers 100 are subdivided according to the position of the seat S or the situation of the occupant and, when the command is input through the integrated switch 400, the temperatures of the warmers are respectively adjusted, thereby providing optimized warming.

Although the exemplary embodiments of the present disclosure have been described for illustrative purposes, those skilled in the art will appreciate that various modifications, additions, and substitutions are possible, without departing from the scope and spirit of the present disclosure as disclosed in the accompanying claims.

What is claimed is:

1. An integrated warmer control system, the system comprising:
a plurality of warmers disposed in and around a seat;
a main controller configured to derive a command signal according to a temperature of an operation stage or a plurality of operation stage-specific operation temperatures of each of the warmers based on situation-specific information; and
a plurality of sub-controllers configured to:
receive the command signal according to the temperature of the operation stage or the plurality of operation stage-specific operation temperatures derived through communication with the main controller; and
control the warmers to operate in response to the command signal.

2. The system of claim 1, wherein each sub-controller is associated with a respective one of the warmers.

3. The system of claim 1, wherein each sub-controller is associated with a group of the warmers.

4. The system of claim 1, wherein, in response to receiving a command input by a user through an integrated switch, the main controller is configured to:
derive the temperature of the operation stage or the plurality of operation stage-specific operation temperatures of each of the warmers; and
transmit the command signal according to the derived temperature of the operation stage or the plurality of operation stage-specific operation temperatures to a corresponding one of the sub-controllers.

5. The system of claim 1, further comprising connection lines electrically connected to each of the sub-controllers, wherein the connection lines are configured to transmit temperature information, contact information, and power, and wherein the sub-controllers are configured to receive the power from an external source and wirelessly communicate with the main controller through the connection lines.

6. The system of claim 1, wherein the main controller is configured to:
receive information regarding a position of the seat and a posture of an occupant of the seat; and
derive the temperature of the operation stage or the plurality of operation stage-specific operation temperatures of each of the warmers based on the information regarding the position of the seat and the posture of the occupant.

7. The system of claim 1, wherein the main controller is configured to:
receive information indicating whether or not an air conditioning system is on or off; and
adjust the temperature of the operation stage or the plurality of operation stage-specific operation temperatures of each of the warmers according to whether or not the air conditioning system is on or off.

8. The system of claim 7, wherein, in response to the information indicating that the air conditioning system is on, the main controller is configured to adjust the temperature of the operation stage or the plurality of operation stage-specific operation temperatures of each of the warmers to a lower temperature according to a duration that the air conditioning system is on.

9. The system of claim 8, wherein, in response to information indicating that the air conditioning system is off, the main controller is configured to adjust the temperature of the operation stage or the plurality of operation stage-specific operation temperatures of each of the warmers to the lower temperature according to the duration that the air conditioning system is on by delaying the adjustment in comparison to a state in which the air conditioning system is on.

10. The system of claim 1, wherein the main controller is configured to:
receive information indicating whether or not a door is opened; and
in response to the information indicating the door is opened, adjust the temperature of the operation stage or the plurality of operation stage-specific operation temperatures of each of the warmers to a lower temperature.

11. The system of claim 10, wherein, in a state in which the door is closed after being opened, the main controller is configured to control the temperature of the operation stage or the plurality of operation stage-specific operation temperatures of the warmers to be higher than the temperature of the operation stage or the plurality of operation stage-specific operation temperatures before the door was opened.

12. The system of claim 1, wherein the main controller is configured to:
receive information indicating whether or not a mobility vehicle has had a collision; and
in response to the information indicating that the mobility vehicle has had the collision, control all of the warmers to be off.

13. An integrated warmer control system, the system comprising:
a plurality of warmers disposed in and around a seat;
a main controller configured to derive a command signal according to a temperature of an operation stage or a plurality of operation stage-specific operation temperatures of each of the warmers based on situation-specific information; and
a plurality of sub-controllers, each sub-controller associated with a corresponding warmer, the sub-controllers configured to:
receive the command signal according to the temperature of the operation stage or the plurality of operation stage-specific operation temperatures derived through communication with the main controller; and
control the warmers to operate in response to the command signal;
wherein, in response to a determination that one of the warmers does not operate at the temperature of the operation stage or the plurality of operation stage-specific operation temperatures, the corresponding sub-controller is configured to transmit an abnormality signal to the main controller; and
wherein, in response to the abnormality signal, the main controller is configured to provide a notification of an abnormal operation of the one of the warmers using a warning system.

14. The system of claim 13, wherein the warmers comprise a first warmer configured to provide heat to a lower body of an occupant of the seat from in front of the seat and a second warmer configured to provide heat to the lower body of the occupant from a side of the seat.

15. The system of claim 14, wherein, in a state in which the seat is converted from a sitting mode into a sleep mode, the main controller is configured to adjust the temperature of the operation stage or the plurality of operation stage-specific operation temperatures of each of the first warmer and the second warmer to a lower temperature based on a position of the seat in the sleep mode.

16. The system of claim 14, wherein, in a state in which the seat is converted from facing a front of a vehicle to a facing mode to face a rear seat, the main controller is configured to control the first warmer to be off and the second warmer to maintain the temperature of the operation stage or the plurality of operation stage-specific operation temperatures.

17. The system of claim 14, wherein:
in a state in which the seat is moved toward the first warmer provided in front of the seat, the main controller is configured to adjust the temperature of the operation stage or the plurality of operation stage-specific operation temperatures of the first warmer to a lower temperature based on a distance of forward movement of the seat; and
in a state in which the seat is moved away from the first warmer, the main controller is configured to adjust the temperature of the operation stage or the plurality of operation stage-specific operation temperatures of the first warmer to a higher temperature based on a distance of backward movement of the seat.

18. The system of claim 13, wherein:
the warmers comprise a third warmer provided on a seatback of the seat and configured to provide heat to a lower body of a rear seat occupant; and
in a state in which the seat is moved backwards or an angle of the seatback is adjusted backward, the main controller is configured to adjust the temperature of the operation stage or the plurality of operation stage-specific operation temperatures of the third warmer to a lower temperature based on a distance of movement of the seat or the angle of the seatback.

19. An integrated warmer control method comprising:
reviewing, by a main controller, situation-specific information according to a situation of a mobility vehicle and an occupant of a seat of the mobility vehicle, the mobility vehicle comprising warmers disposed in and around the seat;
deriving, by the main controller, a temperature of an operation stage or a plurality of operation stage-specific operation temperatures of each of the warmers based on the situation-specific information;
transmitting the temperature of the operation stage or the plurality of operation stage-specific operation temperatures of each of the warmers derived by the main controller to a plurality of sub-controllers; and
operating, by the sub-controllers, the warmers, each sub-controller controlling one or more of the warmers.

20. The method of claim 19, further comprising receiving, by the main controller, a command for operating the warmers from the occupant before reviewing the situation-specific information.
